(19) United States
(12) Patent Application Publication
(10) Pub. No.: US 2026/0368140 A1
(43) Pub. Date: Nov. 19, 2026

(54) DATA COPYING APPARATUS, DATA COPYING SYSTEM, DATA COPYING METHOD, AND DATA COPYING PROGRAM

(71) Applicant: NTT, Inc., Tokyo (JP)

(72) Inventors: Takuya NAKAMURA, Musashino-shi, Tokyo (JP); Takeshi OGURO, Musashino-shi, Tokyo (JP); Kazuyuki TAKAYA, Musashino-shi, Tokyo (JP); Kei OMURA, Musashino-shi, Tokyo (JP)

(21) Appl. No.: 19/120,991

(22) PCT Filed: Oct. 25, 2022
(86) PCT No.: PCT/JP2022/039724

§ 371 Date: Apr. 14, 2025

(51) Int. Cl. G06F 16/174

(52) U.S. Cl. CPC G06F 16/1748

(57) ABSTRACT

A transmission/reception part (213) for receiving a first difference (D1) indicating a change that has occurred in an immediate file in real-time processing, a transmission/reception part (221) for receiving a second difference (D2) indicating a change that has occurred in at least one of an immediate file and a non-immediate file in batch processing, a temporary storage part (214) that updates the immediate file by using the first difference (D1) when the first difference (D1) is received, a duplicate data storage part (222) that updates at least one of the immediate file and the non-immediate file by using the second difference (D2) when the second difference (D2) is received, an identical-file determination part (213) that determines whether an overlapping immediate file is present in the temporary storage part (214) and the duplicate data storage part (222), and a concealment processing part (display control part or deletion control part) that conceals or deletes the immediate file stored in the temporary storage part (214) or the duplicate data storage part (222) when it is determined that an overlapping immediate file is present.

### TECHNICAL FIELD

The present invention relates to a data duplication device, a data duplication system, a data duplication method, and a data duplication program.

### BACKGROUND ART

NPL 1 discloses that a server serving as a transmission destination (hereinafter referred to as a “transmission destination server”) acquires duplicate data by synchronizing original data stored in a data storage device of a server serving as a transmission source (hereinafter referred to as a “transmission source server”), and a file requested by a user is provided on demand based on the duplicate data.

The original data includes a plurality of files to be used in a cache system or the like, and when a change such as addition of a new file, modification or deletion of an existing file, or the like occurs, the changed file is transmitted from the transmission source server to the transmission destination server. The transmission destination server synchronizes the original data with the duplicate data based on the transmitted changed file, and updates the duplicate data.

### CITATION LIST

### Non Patent Literature

[NPL 1] Alluxio Introduction, https://docs.alluxio.io/os/user/stable/en/Overview.html

### SUMMARY OF INVENTION

### Technical Problem

Files included in the original data include an immediate file having immediacy and a non-immediate file having no immediacy. When the immediate file is changed, the immediate file is transmitted from the transmission source server to the transmission destination server in real-time processing (online processing) to update files. When a change occurs in a non-immediate file included in the original data, the difference information of all the files (the immediate files and the non-immediate files) is transmitted from the transmission source server to the transmission destination server in batch processing at a certain time interval or at an arbitrary timing to update files.

In the technique disclosed in NPL 1, when an immediate file in which a change has occurred is transmitted from the transmission source server in real-time processing, the corresponding immediate file stored in the temporary storage part is updated based on the aforementioned immediate file. In addition, when a file in which a change has occurred is transmitted from the transmission source server in batch processing, files (an immediate file and a non-immediate file) stored in the duplicate data storage part of the transmission destination server are updated based on the aforementioned file.

Therefore, there may be a problem of the user of the file being confused with recognition that identical immediate files are present in a plurality of directories. Furthermore, one immediate file is stored in each of the temporary storage part and the duplicate data storage part, causing a problem that resources of the storage areas are unnecessarily used.

The present invention has been made in view of the above-mentioned circumstances, and an object of the present invention is to provide a data duplication device, a data duplication system, a data duplication method, and a data duplication program that enable avoidance of overlapping access to a plurality of storage parts for an identical file.

### Solution to Problem

A data duplication device according to an aspect of the present invention is a data duplication device for generating duplicate data of original data, the data duplication device including a reception part that receives a first difference indicating a change that has occurred in an immediate file included in the original data in real-time processing and receives a second difference indicating a change that has occurred in at least one of an immediate file and a non-immediate file included in the original data in batch processing, a temporary storage part that stores duplicate data of the immediate file and updates the immediate file by using the first difference when the first difference is received, a duplicate data storage part that stores duplicate data of at least one of the immediate file and the non-immediate file and updates at least one of the immediate file and the non-immediate file by using the second difference when the second difference is received, a determination part that determines whether an overlapping immediate file is present in the temporary storage part and the duplicate data storage part, and a concealment processing part that conceals or deletes the immediate file stored in the temporary storage part or the duplicate data storage part when it is determined that an overlapping immediate file is present.

A data duplication system according to an aspect of the present invention is a data duplication system including one server and another server connected to the one server, in which the other server includes an original data storage part that stores original data including a plurality of files, a difference determination part that determines a file in which a change has occurred among the plurality of files, an immediacy determination part that determines whether the file in which the change has occurred is an immediate file or a non-immediate file, and a transmission part that transmits a first difference indicating a change that has occurred in the immediate file to the one server in real-time processing and transmits a second difference indicating a change that has occurred in at least one of the immediate file and the non-immediate file to the one server in batch processing, and the one server includes a reception part that receives the first difference and the second difference, a temporary storage part that stores duplicate data of the immediate file and updates the immediate file by using the first difference when the first difference is received, a duplicate data storage part that stores duplicate data of at least one of the immediate file and the non-immediate file and updates at least one of the immediate file and the non-immediate file by using the second difference when the second difference is received, a determination part that determines whether an overlapping immediate file is present in the temporary storage part and the duplicate data storage part, and a concealment processing part that conceals or deletes the immediate file stored in the temporary storage part of the duplicate data storage part when it is determined that an overlapping immediate file is present.

A data duplication method according to an aspect of the present invention includes a step of receiving a first difference indicating a change that has occurred in an immediate file included in the original data in real-time processing, a step of receiving a second difference indicating a change that has occurred in at least one of an immediate file and a non-immediate file included in the original data in batch processing, a step of storing duplicate data of the immediate file in a temporary storage part and updating the immediate file by using the first difference when the first difference is received, a step of storing duplicate data of at least one of the immediate file and the non-immediate file in a duplicate data storage part and updating at least one of the immediate file and the non-immediate file by using the second difference when the second difference is received, a step of determining whether an overlapping immediate file is present in the temporary storage part and the duplicate data storage part, and a step of concealing or deleting the immediate file stored in the temporary storage part or the duplicate data storage part when it is determined that an overlapping immediate file is present.

An aspect of the present invention is a data duplication program for causing a computer to function as the data duplication device.

### Advantageous Effects of Invention

According to the present invention, it is possible to avoid overlapping access to a plurality of storage parts for an identical file.

### brief DESCRIPTION OF DRAWINGS

FIG. 1 is a block diagram illustrating a configuration of a data duplication system according to an embodiment.

FIG. 2 is a flowchart showing a processing procedure of the data duplication system according to an embodiment.

FIG. 3 is a block diagram illustrating a configuration of a data duplication system according to a first modification.

FIG. 4 is a flowchart showing a processing procedure of the data duplication system according to the first modification.

FIG. 5 is a block diagram illustrating a configuration of a data duplication system according to a second modification.

FIG. 6 is a block diagram illustrating a hardware configuration of the present embodiment.

### DESCRIPTION OF EMBODIMENTS

### Description of Embodiments

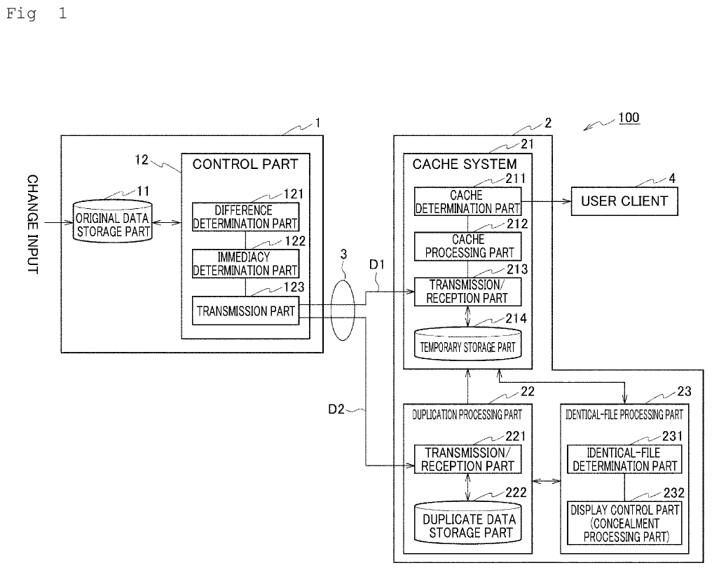

Embodiments will be explained below with reference to the drawings. FIG. 1 is a block diagram illustrating a configuration of a data duplication system according to an embodiment. As illustrated in FIG. 1, the data duplication system 100 includes a transmission source server 1 (another server) and a transmission destination server 2 (one server or a data duplication device), and the transmission source server 1 and the transmission destination server 2 are connected by a network 3. The transmission destination server 2 is connected to a user client 4. The data duplication system 100 transmits a file stored in the transmission source server 1 to the transmission destination server 2 to generate a duplicate file.

The transmission source server 1 includes an original data storage part 11 and a control part 12.

The original data storage part 11 stores original data including a plurality of files to be used in a cache system 21 to be described below. The files stored in the original data storage part 11 undergo change processing at a certain time interval or at an arbitrary timing through access from the outside. The change processing includes addition of a new file to the original data, and correction and deletion of an existing file included in the original data.

The original data includes an immediate file having immediacy and a non-immediate file having no immediacy. Hereinafter, an immediate file subjected to change processing among a plurality of files included in the original data is referred to as a “first difference D1”. In addition, a file (an immediate file or a non-immediate file) subjected to change processing among the plurality of files included in the original data is referred to as a “second difference D2”. An immediate file is a file that needs to be immediately referred to when change processing occurs, for example, a “csv” file or a file including image data such as “jpeg”, “mpeg”, or the like. An immediate file may be a file for managing the content and location of the original data. A non-immediate file is a file requiring no immediacy.

The control part 12 includes a difference determination part 121, an immediacy determination part 122, and a transmission part 123.

The difference determination part 121 determines a file (second difference) in which change processing has occurred among a plurality of files stored in the original data storage part 11.

The immediacy determination part 122 determines whether the file for which the difference determination part 121 determined that the change processing has occurred is an immediate file or a non-immediate file.

The transmission part 123 transmits an immediate file (first difference D1) in which change processing has occurred, and an immediate file and a non-immediate file (second difference D2) in which change processing has occurred to the transmission destination server 2 based on the determination result from the immediacy determination part 122. Specifically, the transmission part 123 transmits the first difference D1 to a cache system 21 of the transmission destination server 2 via a network 3 through real-time processing. The transmission part 123 transmits the second difference D2 to a duplication processing part 22 of the transmission destination server 2 via the network 3 through batch processing for transmitting the second difference D2 at a certain time interval or at an arbitrary timing.

The transmission destination server 2 includes the cache system 21, a duplication processing part 22, and an identical-file processing part 23. The cache system 21, the duplication processing part 22, and the identical-file processing part 23 constitute the data duplication device of the present invention.

The cache system 21 includes a cache determination part 211, a cache processing part 212, a transmission/reception part 213 (reception part), and a temporary storage part 214.

The cache determination part 211 determines whether a request file requested by the user of the user client 4 is present in cache data stored in the temporary storage part 214.

When the cache determination part 211 determines that the request file is present in the cache data, the cache processing part 212 outputs, to the transmission/reception part 213, a control command for transmitting the cache data of the request file to the user client 4.

When the cache determination part 211 determines that the request file is not present in the cache data, the cache processing part 212 acquires the request file from a duplicate data storage part 222 to be described later, and stores the request file in the temporary storage part 214. The cache processing part 212 outputs a control command for transmitting the cache data of the request file to the user client 4 to the transmission/reception part 213. The user of the user client 4 can execute various kinds of processing by using the file provided from the cache system 21.

The transmission/reception part 213 receives the first difference D1 transmitted from the transmission part 123 of the transmission source server 1, outputs the first difference to the temporary storage part 214, and updates the corresponding immediate file. At this time, the attribute of the immediate file is stored as master data. The “master data” is an attribute permanently stored in the cache system 21. The transmission/reception part 213 has a function as a reception part for receiving a first difference when a change occurs in an immediate file included in the original data and the first difference D1 being the immediate file in which the change has occurred is transmitted in real-time processing.

The transmission/reception part 213 transmits the cache data of the file read by the cache processing part 212 in response to the request from the user client 4 to the user client 4.

The temporary storage part 214 stores cache data to be used in the cache system 21. The cache data includes duplicate data of the immediate file included in the original data. The temporary storage part 214 stores the duplicate data of the immediate file, and updates the immediate file corresponding to the first difference D1 when the first difference D1 is received by the transmission/reception part 213. When a request file (an immediate file or a non-immediate file) requested from the user client 4 is stored in the duplicate data storage part 222 to be described below, the temporary storage part 214 acquires the request file from the duplicate data storage part 222 and stores the request file.

The duplication processing part 22 includes a transmission/reception part 221 (reception part) and the duplicate data storage part 222.

The transmission/reception part 221 receives a second difference D2 transmitted from the transmission source server 1. As described above, the second difference D2 is an immediate file and a non-immediate file in which a change has occurred. The transmission/reception part 221 receives a file read command when the command is output from the cache processing part 212, reads the corresponding file stored in the duplicate data storage part 222, and transmits the file to the cache system 21. This file is stored in the temporary storage part 214. The transmission/reception part 221 has a function as a reception part for receiving the second difference D2 when a change occurs in at least one of the immediate file and the non-immediate file included in the original data and the second difference D2 being the file in which the change has occurred is transmitted in batch processing.

The duplicate data storage part 222 stores duplicate data of the immediate file and the non-immediate file included in the original data stored in the original data storage part 11. The duplicate data storage part 222 stores duplicate data of the immediate file and the non-immediate file, and updates at least one of the immediate file and the non-immediate file corresponding to the second difference D2 when the second difference D2 is received.

The identical-file processing part 23 includes an identical-file determination part 231 and a display control part 232 (concealment processing part). The identical-file processing part 23 can change a part of a program of the cache system 21, for example, to set the program of the cache system 21. In addition, the identical-file processing part 23 can set the program by implementing the program in an external system linked to the cache system 21 via an interface.

The identical-file determination part 231 determines whether the immediate file (cache data whose attribute is stored as master data) stored in the temporary storage part 214 is identical to the immediate file stored in the duplicate data storage part 222. Since the immediate file stored in the temporary storage part 214 is updated based on the first difference D1 as described above, the immediate file overlaps the immediate file updated based on the second difference D2 in the duplicate data storage part 222. That is, the identical immediate file is stored in the temporary storage part 214 and the duplicate data storage part 222 in an overlapping manner.

The identical-file determination part 231 may execute identity determination processing each time a predetermined time elapses, for example. The identical-file determination part 231 may execute identity determination processing triggered by the completion of file update based on the second difference D2 in the duplicate data storage part 222.

The identical-file determination part 231 determines whether a file is an identical file by adopting the following methods (A) to (C), for example.
(A) Identity is determined by comparing the cache data stored in the temporary storage part 214 with the file name of the immediate file stored in the duplicate data storage part 222.
(B) Identity is determined by comparing the cache data stored in the temporary storage part 214 with meta information such as a file size, file creation date and time, and file update date and time of the immediate file stored in the duplicate data storage part 222.
(C) Identity is determined by comparing the cache data stored in the temporary storage part 214 with the hash value of the immediate file stored in the duplicate data storage part 222.

That is, the identical-file determination part 231 determines whether the identical immediate file is present in the temporary storage part 214 and the duplicate data storage part 222 by using at least one of the file name, the file size, the file creation date and time, the file update date and time, and the file hash value of the immediate file.

When the identical-file determination part 231 determines that identical files are present, the above-described cache processing part 212 changes the attribute of the cache data of the corresponding immediate file stored in the temporary storage part 214 from “master data” which is an attribute permanently stored in the cache system to “cache” which is an attribute for deleting the file based on a predetermined condition. The predetermined condition can be at least one of, for example, a case in which the use period of the file reaches a certain period, a case in which the period during which the file has not been used reaches a certain period, and a case in which the storage capacity of the temporary storage part 214 reaches a predetermined threshold.

The display control part 232 displays a file usable by the user client 4 on a display part such as a display. A user of the user client 4 can select a file to be used by browsing the usable file. Further, the file may be presented by voice or the like, in addition to being displayed on the display part. When the identical-file determination part 231 determines that identical files are present, the display control part 232 conceals the corresponding file stored in the duplicate data storage part 222 so as not to be browsed by the user. As processing for concealing the file, a method for preventing all file users from referring to an immediate file to be concealed by using an Access Control List (ACL) function of the cache system 21 can be used.

Thus, the immediate file stored in the temporary storage part 214 and the identical immediate file stored in the duplicate data storage part 222 can be prevented from being displayed on the display part in an overlapping manner. That is, the display control part 232 has a function as a concealment processing part for concealing the corresponding immediate file stored in the duplicate data storage part 222 when the identical-file determination part 231 determines that identical immediate files are present.

When the target immediate file is deleted from the temporary storage part 214, the display control part 232 releases the concealment of the immediate file. That is, the display control part 232 has a function of deleting the concealed immediate file stored in the temporary storage part 214 and releasing the concealment of the concealed immediate file stored in the duplicate data storage part 222 when a request for acquiring the concealed immediate file has not been made by the user for a certain period or the concealed immediate file has not been used for a certain period.

### Operation of First Embodiment

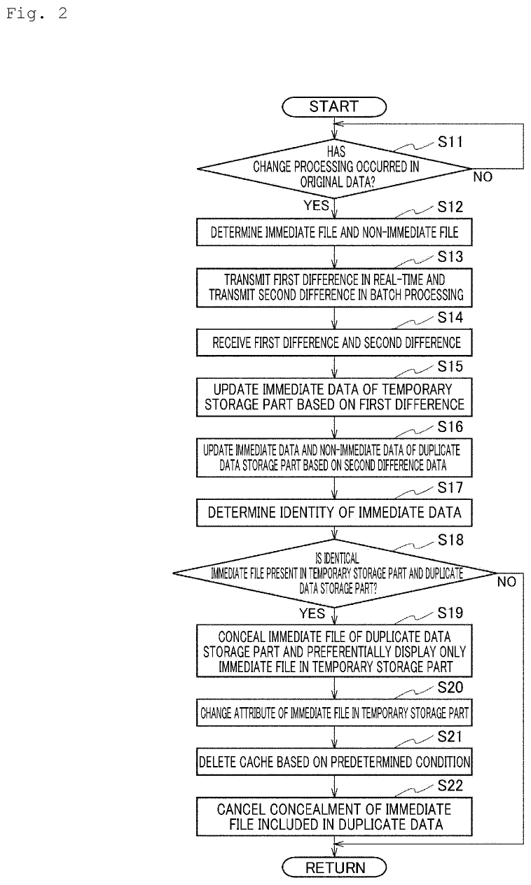

Next an operation of the data duplication system 100 according to the first embodiment will be described with reference to the flowchart shown in FIG. 2.

First, in step S11 of FIG. 2, the difference determination part 121 of the transmission source server 1 determines whether change processing has occurred in various files included in the original data stored in the original data storage part 11.

When the change processing has occurred (S11; YES), the immediacy determination part 122 determines whether the file in which the change has occurred is an immediate file or a non-immediate file in step S12.

In step S13, the transmission part 123 transmits the immediate file (first difference D1) in which the change processing has occurred to the cache system 21 of the transmission destination server 2 in real-time processing. The transmission part 123 transmits the immediate file and the non-immediate file (second difference D2) in which the change processing has occurred to the duplication processing part 22 of the transmission destination server 2 in batch processing at a certain time interval or at an arbitrary timing.

In step S14, the transmission/reception part 213 of the cache system 21 receives the first difference D1 transmitted in the real-time processing. The transmission/reception part 221 of the duplication processing part 22 receives the second difference D2 transmitted in the batch processing.

In step S15, the cache processing part 212 of the cache system 21 updates the corresponding immediate file of the cache data stored in the temporary storage part 214 based on the first difference D1. That is, the cache data of the immediate file stored in the temporary storage part 214 is updated with the immediate file subjected to the change processing. The immediate file is stored as master data which is an attribute permanently stored in the cache system.

In step S16, the transmission/reception part 221 of the duplication processing part 22 updates the corresponding file of each file (the immediate file or the non-immediate file) stored in the duplicate data storage part 222 based on the second difference D2. That is, the corresponding immediate file and non-immediate file of the duplicate data stored in the duplicate data storage part 222 are updated with the file subjected to the change processing.

In step S17, the identical-file determination part 231 determines the identity of the immediate file stored in the temporary storage part 214 and the immediate file stored in the duplicate data storage part 222. Any of the methods in (A) to (C) described above can be adopted for the determination of identity.

When it is determined that the identical immediate files are present in step S18 (S18; YES), the processing proceeds to step S19, and when it is not (S18; NO), the processing ends.

In step S19, the display control part 232 conceals the corresponding immediate file stored in the duplicate data storage part 222, and outputs display information to the cache system 21 to preferentially display only the immediate file stored in the temporary storage part 214. As a result, the user client 4 can browse only the immediate file stored in the temporary storage part 214 among the overlapping immediate files.

For example, since the ACL function of the cache system 21 prevents all file users from referring to the immediate file, the user can make only the immediate file stored in the temporary storage part 214 browsable. When the user of the user client 4 requests acquisition of the file in this state, the immediate file stored in the temporary storage part 214 is transferred to the user client 4, and the user can acquire the immediate file.

In step S20, the cache processing part 212 changes the attribute of the cache data of the immediate file stored in the temporary storage part 214 from “master data” which is an attribute permanently stored in the cache system to “cache” which is an attribute for deleting the file based on a predetermined condition.

In step S21, the cache processing part 212 deletes the cache of the immediate data stored in the temporary storage part 214 under the above-described predetermined condition. For example, when the use period of the file reaches a certain period, when the period in which the file has not been used reaches a certain period, or when the storage capacity of the temporary storage part 214 reaches a predetermined threshold, the cache of the immediate data stored in the temporary storage part 214 is deleted.

In step S22, the display control part 232 releases the concealment of the concealed immediate file stored in the duplicate data storage part 222 to allow the user of the user client 4 to browse the immediate file. Therefore, the user can continuously browse the immediate file deleted from the temporary storage part 214. That is, when the immediate file stored in the temporary storage part 214 is deleted, the concealed state of the corresponding immediate file stored in the duplicate data storage part 222 is released, and thus the user can browse the immediate file.

Thereafter, when a request for acquiring the file is made by the user of the user client 4, the cache of the target immediate file stored in the duplicate data storage part 222 is stored in the temporary storage part 214 via the cache system 21. As a result, the user can acquire the requested file. Thereafter, the present processing ends.

As described above, the data duplication device according to the present embodiment is a data duplication device for generating duplicate data of original data, the data duplication device including the reception parts (the transmission/reception parts 213 and 221) that receives a first difference indicating a change that has occurred in an immediate file included in the original data in real-time processing and receives a second difference indicating a change that has occurred in at least one of an immediate file and a non-immediate file included in the original data in batch processing, the temporary storage part 214 that stores the duplicate data of the immediate file and updates the immediate file by using the first difference when the first difference is received, the duplicate data storage part 222 that stores duplicate data of at least one of the immediate file and the non-immediate file and updates at least one of the immediate file and the non-immediate file by using the second difference when the second difference is received, the determination part (the identical-file determination part 231) that determines whether an overlapping immediate file is present in the temporary storage part 214 and the duplicate data storage part 222, and the display control part 232 (the concealment processing part) that conceals or deletes the immediate file stored in the temporary storage part 214 or the duplicate data storage part 222 when it is determined that an overlapping immediate file is present.

In the data duplication system 100 according to the present embodiment, when a change occurs in an immediate file stored in the original data storage part 11, the changed immediate file (first difference D1) is transmitted to the cache system 21 in real-time processing, and the corresponding immediate file stored in a temporary storage part 214 is updated. Thus, the user of the user client 4 can quickly acquire and use the updated immediate file.

In addition, when a change occurs in the immediate file and the non-immediate file stored in the original data storage part 11, the changed immediate file and non-immediate file (second difference D2) are transmitted to the duplication processing part 22 in batch processing, and the immediate file and the non-immediate file stored in the duplicate data storage part 222 are updated. Thus, the user of the user client 4 can use the updated immediate file and non-immediate file after transmission of the second difference D2 in batch processing.

Furthermore, when identical immediate files are present in the temporary storage part 214 and the duplicate data storage part 222, the corresponding immediate file stored in the duplicate data storage part 222 is concealed. For this reason, the user of the user client 4 can retrieve the cache of the immediate file stored in the temporary storage part 214. In addition, the immediate file stored in the duplicate data storage part 222 cannot be retrieved. Thus, the problem of a plurality of the identical files being retrieved in an overlapping manner that causes the user to be confused can be avoided.

The immediate file stored as a cache in the temporary storage part 214 is deleted from the temporary storage part 214 when a predetermined condition such as passage of a certain period of time is met. At this time, the concealment of the corresponding immediate file stored in the duplicate data storage part 222 is canceled, and the state is changed to a state in which the user of the user client 4 is allowed to retrieve the file.

Therefore, overlapping storage of identical files can be prevented, and unnecessary use of resources of the storage area can be avoided. In addition, after the immediate file stored as a cache in the temporary storage part 214 is deleted, the immediate file is stored in the duplicate data storage part 222, and thus the user can continuously retrieve the immediate file.

### Explanation of First Modification

Next, a first modification will be described. In the above-described embodiment, when an immediate file identical to an immediate file stored in the temporary storage part 214 is stored in the duplicate data storage part 222, the identical immediate file is prevented from being retrieved by the user in an overlapping manner by preventing overlapping display of the immediate file stored in the duplicate data storage part 222.

On the other hand, in a data duplication system according to the first modification, when an immediate file is stored in the duplicate data storage part 222, if an immediate file identical to the immediate file is stored in the temporary storage part 214, the corresponding immediate file stored in the temporary storage part 214 is deleted, and thus overlapping retrieval of the identical immediate file by a user is prevented. This will be explained in detail below.

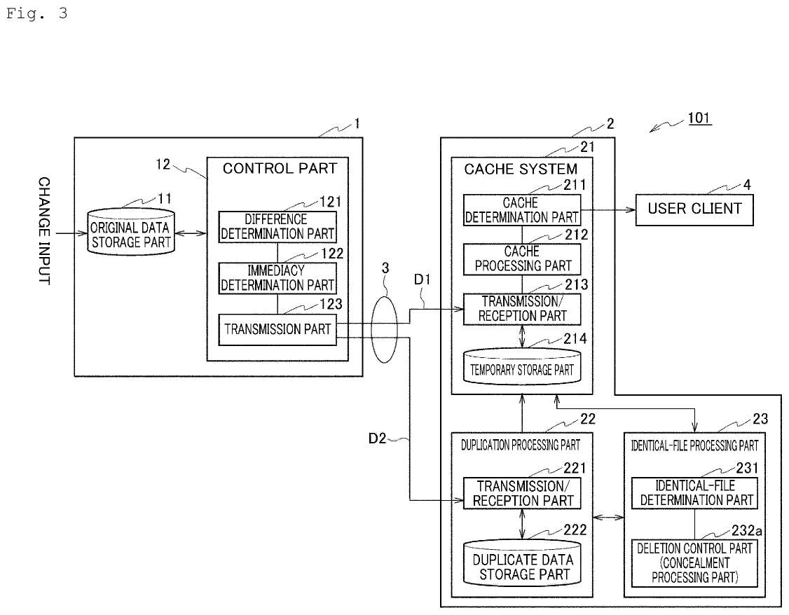

FIG. 3 is a block diagram illustrating a configuration of a data duplication system 101 according the first modification. The data duplication system 101 illustrated in FIG. 3 differs from the above-mentioned system in FIG. 1 in that a deletion control part 232a is provided instead of the display control part 232. Since other configurations are the same as those in FIG. 1, the same reference numerals will be given and descriptions of the configurations will be omitted.

When an immediate file identical to an immediate file stored in the duplicate data storage part 222 is stored in the temporary storage part 214, the deletion control part 232a illustrated in FIG. 3 deletes the corresponding immediate file stored in the temporary storage part 214. That is, the deletion control part 232a has a function as a concealment processing part for deleting the immediate file stored in the temporary storage part 214 when the identical-file determination part 231 determines that an identical immediate file is present.

Since the second difference D2 is transmitted in batch processing as described above, the second difference is received by the transmission destination server 2 later than the first difference D1 transmitted in real-time processing. Therefore, a time difference is made between the time when the immediate file is updated in real time in the temporary storage part 214 and the time when the immediate file stored in the duplicate data storage part 222 is updated.

When the file stored in the duplicate data storage part 222 is updated based on the second difference D2, that is, after a certain period of time elapses from the transmission of the first difference D1 in the real-time processing, there is a high possibility that the use frequency of the immediate file has already been lowered. Therefore, it is assumed that, even if the immediate file stored in the temporary storage part 214 is deleted, no significant influence is generated.

Therefore, when the immediate file is stored in the duplicate data storage part 222, it is possible to avoid overlapping presence of the immediate file by deleting the identical immediate file stored in the temporary storage part 214. That is, the deletion control part 232a has a function as a concealment processing part for deleting the immediate file stored in the temporary storage part 214.

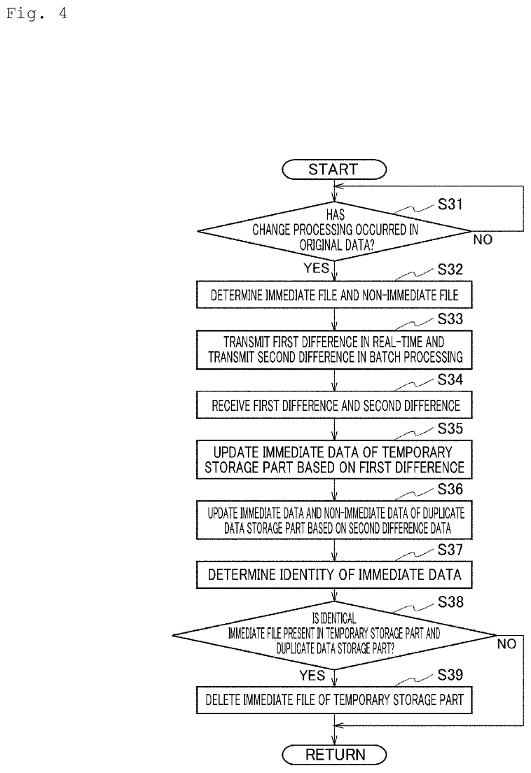

Next, an operation of the first modification will be described with reference to the flowchart shown in FIG. 4. Since steps S31 to S38 shown in FIG. 4 are the same as steps S11 to S18 shown in FIG. 2, description thereof will be omitted.

In the first modification, when it is determined that identical immediate files are present in the temporary storage part 214 and the duplicate data storage part 222 (S38; YES) in step S38, the deletion control part 232a deletes the corresponding immediate file stored in the temporary storage part 214 in step S39.

Therefore, the overlapping presence of the immediate file stored in the temporary storage part 214 and the immediate file stored in the duplicate data storage part 222 can be avoided, and the problem of the user being confused can be avoided.

### Explanation of Second Modification

Next, a second modification will be described. In the above-described embodiment, an example in which the cache system 21, the duplication processing part 22, and the identical-file processing part 23 are provided in the one transmission destination server 2 (data duplication device) has been described. The second modification differs from the above-described embodiment in that a server provided with the cache system 21 and the identical-file processing part 23 is different from a server provided with the duplication processing part 22.

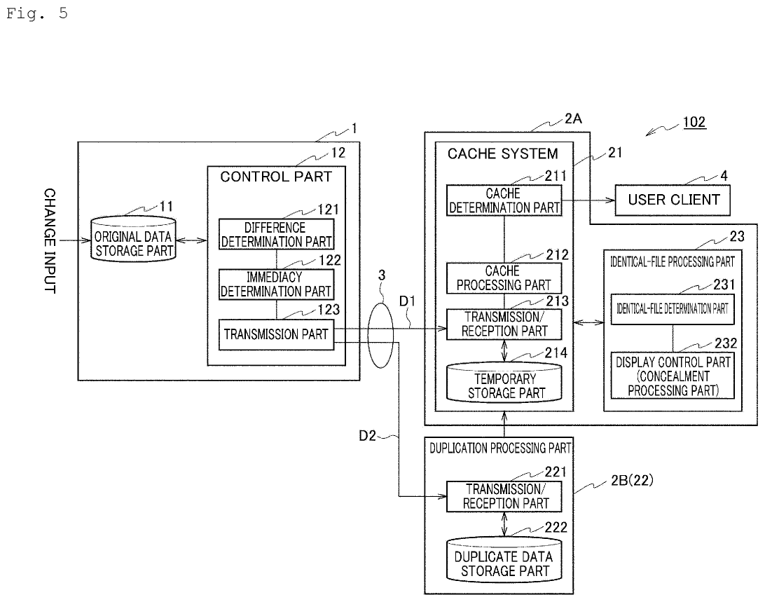

FIG. 5 is a block diagram illustrating a configuration of a data duplication system 102 according the second modification. As illustrated in FIG. 5, the data duplication system 102 according to the second modification includes a transmission source server 1, a server 2A, and a server 2B, each of the servers 1, 2A and 2B are connected on a network 3. The server 2A is connected to a user client 4. The two servers 2A and 2B constitute the data duplication device of the present invention.

The server 2A includes a cache system 21 and an identical-file processing part 23. The server 2B includes a duplication processing part 22. The cache system 21, the duplication processing part 22, and the identical-file processing part 23 have the same configuration as that of the aforementioned embodiment.

The data duplication system 102 according to the second modification is the same as the embodiment illustrated in FIG. 1 in configuration and operation except that communication between the server 2A and the server 2B is performed via a communication network such as a network, and thus the same reference numerals are given to omit detailed description thereof.

In the data duplication system 102 according to the second modification, processing using a cache can be performed by the cache system 21 of the server 2A installed at a place different from the server 2B where the duplication processing part 22 is installed as described above. Therefore, restriction on the installation place of each constituent component can be avoided, and the flexibility can be improved.

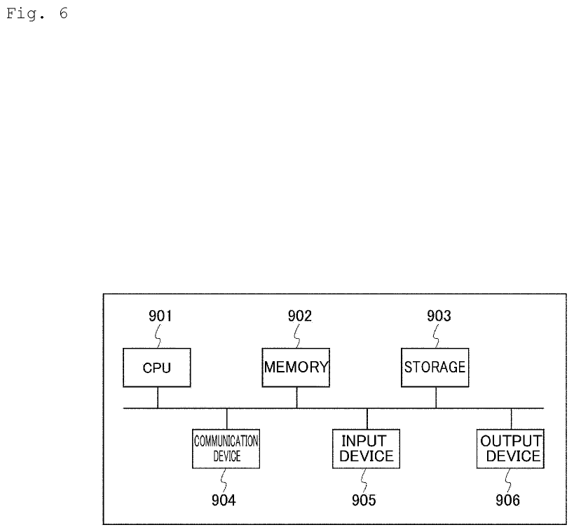

The data duplication device (transmission destination server 2) of the present embodiment described above can use a general-purpose computer system that includes, for example, a central processing part (CPU; processor) 901, a memory 902, a storage 903 (hard disk drive (HDD) or solid state drive (SSD) ), a communication device 904, an input device 905, and an output device 906 as illustrated in FIG. 6. The memory 902 and the storage 903 are storage devices. In this computer system, each function of the data duplication device (server 2) is realized by the CPU 901 executing a predetermined program loaded on the memory 902.

Further, the data duplication device (server 2) may be mounted in one computer or may be mounted in a plurality of computers. In addition, the data duplication device (server 2) may be a virtual machine mounted in a computer. The data duplication device (server 2) may be configured on a cloud. The server 1 (transmission source server) may also be configured on a cloud.

Further, a program for the data duplication device (server 2) can be stored in a computer-readable recording medium such as an HDD, an SSD, a Universal Serial Bus (USB) memory, a compact disc (CD), and a digital versatile disc (DVD) or distributed over a network. The computer-readable recording medium is, for example, a non-transitory recording medium.

Further, the present invention is not limited to the above-described embodiments, and numerous modifications can be made within the scope and gist of the invention.

### REFERENCE SIGNS LIST

1 Transmission source server (another server)
2 Transmission destination server (one server or data duplication device)
2A, 2B Server
3 Network
4 User client
11 Original data storage part
12 Control part
21 Cache system
22 Duplication processing part
23 Identical-file processing part
100, 101, 102 Data duplication system
121 Difference determination part
122 Immediacy determination part
123 Transmission part
211 Cache determination part
212 Cache processing part
213 Transmission/reception part (reception part)
214 Temporary storage part
221 Transmission/reception part (reception part)
222 Duplicate data storage part
231 Identical-file determination part (determination part)
232 Display control part (concealment processing part)
232a Deletion control part (concealment processing part)
D1 First difference
D2 Second difference

1. A data duplication device for generating duplicate data of original data, the data duplication device includes one or more processors configured to:
receive a first difference indicating a change that has occurred in an immediate file included in the original data in real-time processing and receive a second difference indicating a change that has occurred in at least one of an immediate file and a non-immediate file included in the original data in batch processing;
store, in a temporary storage part, duplicate data of the immediate file and update the immediate file by using the first difference when the first difference is received;
store, in a duplicate data storage part, duplicate data of at least one of the immediate file and the non-immediate file and update at least one of the immediate file and the non-immediate file by using the second difference when the second difference is received;
determine whether an overlapping immediate file is present in the temporary storage part and the duplicate data storage part; and
conceal or delete the immediate file stored in at least one of the temporary storage part or the duplicate data storage part when it is determined that an overlapping immediate file is present.

2. The data duplication device according to claim 1, wherein the data duplication device is configured to conceal the overlapping immediate file stored in the duplicate data storage part and prevent the immediate file from being referred to when it is determined that the overlapping immediate data is present.

3. The data duplication device according to claim 2, wherein the data duplication device is configured to delete the overlapping immediate file stored in the temporary storage part and cancel concealment of the concealed immediate file stored in the duplicate data storage part in at least one case among a case in which a request for acquiring the overlapping immediate file has not been made by a user for a certain period, a case in which the overlapping immediate file has not been used for a certain period, and a case in which a storage capacity of the temporary storage part reaches a predetermined threshold.

4. The data duplication device according to claim 1, wherein the data duplication device is configured to delete the immediate file stored in the temporary storage part when it is determined that the overlapping immediate data is present.

5. The data duplication device according to claim 1, wherein the data duplication device is configured to determine whether an identical immediate file is present in the temporary storage part and the duplicate data storage part by using at least one of a file name, a file size, a file creation date and time, a file update date and time, and a file hash value of the immediate file.

6. A data duplication system comprising:
one server; and
another server connected to the one server,
wherein the other server includes one or more processors configured to:
store original data including a plurality of files;
determine a file in which a change has occurred among the plurality of files;
determine whether the file in which the change has occurred is an immediate file or a non-immediate file; and
transmit a first difference indicating a change that has occurred in the immediate file to the one server in real-time processing and transmit a second difference indicating a change that has occurred in at least one of the immediate file and the non-immediate file to the one server in batch processing, and
the one server includes one or more processors configured to:
receive the first difference and the second difference;
store, in a temporary storage part, duplicate data of the immediate file and update the immediate file by using the first difference when the first difference is received;
store, in a duplicate data storage part, duplicate data of at least one of the immediate file and the non-immediate file and update at least one of the immediate file and the non-immediate file by using the second difference when the second difference is received;
determine whether an overlapping immediate file is present in the temporary storage part and the duplicate data storage part; and
conceal or delete the immediate file stored in the temporary storage part or the duplicate data storage part when it is determined that an overlapping immediate file is present.

7. A data duplication method comprising:
receiving a first difference indicating a change that has occurred in an immediate file included in original data in real-time processing;
receiving a second difference indicating a change that has occurred in at least one of an immediate file and a non-immediate file included in the original data in batch processing;
storing duplicate data of the immediate file in a temporary storage part and updating the immediate file by using the first difference when the first difference is received;
storing duplicate data of at least one of the immediate file and the non-immediate file in a duplicate data storage part and updating at least one of the immediate file and the non-immediate file by using the second difference when the second difference is received;
determining whether an overlapping immediate file is present in the temporary storage part and the duplicate data storage part; and
concealing or deleting the immediate file stored in at least one of the temporary storage part or the duplicate data storage part when it is determined that an overlapping immediate file is present.

8. (canceled)
